(19) United States
(12) Patent Application Publication
(10) Pub. No.: US 2016/0148726 A1
(43) Pub. Date: May 26, 2016

(54) PRINTING OF MICRO WIRES

(71) Applicant: Elwha LLC, Bellevue, WA (US)

(72) Inventors: William D. Duncan, Mill Creek, WA (US); Roderick A. Hyde, Redmond, WA (US); Jordin T. Kare, Seattle, WA (US); Lowell L. Wood,, Jr., Bellevue, WA (US)

(73) Assignee: ELWHA LLC, Bellevue, WA (US)

(21) Appl. No.: 14/549,215

(22) Filed: Nov. 20, 2014

(51) Int. Cl. H01B 13/06

(52) U.S. Cl. CPC H01B 13/06

(57) ABSTRACT

A printing device for printing of micro wires includes a first reservoir configured to hold an insulator, and a second reservoir configured to hold a low-melting-temperature metal. The printing device further includes a print head configured to deposit the insulator and the low-melting-temperature metal in contact with each other over at least a portion of a substrate. The printing device further includes a processing circuit configured to receive data specifying a structure to be printed and control the operation of the print head based on the data.

### BACKGROUND

Gallium (Ga) is a chemical element that is not found in a pure form in nature. At low temperatures, gallium takes the form of a soft metal, which will melt at slightly above room temperature (85.57° F.). Because of this characteristic, gallium's melting point is used as one of the formal temperature reference points in the International Temperature Scale of 1990. Typically, gallium is used as an agent to create alloys that melt at low temperatures, where the majority of alloys formed from gallium are found in electronic components.

### SUMMARY

One embodiment relates to a printing device for printing of micro wires. The device comprises a first reservoir configured to hold an insulator, a second reservoir configured to hold a low-melting-temperature metal, a print head, and a processing circuit. The print head is configured to deposit the insulator and the low-melting-temperature metal in contact with each other over at least a portion of a substrate. The processing circuit is configured to receive data specifying a structure to be printed and control the operation of the print head based on the data.

Another embodiment relates to a method of printing micro wires. The method comprises holding, in a first reservoir, an insulator; holding, in a second reservoir, a low-melting-temperature metal; receiving data specifying a structure to be printed at a printing device; and controlling the operation of a print head of the printing device based on the data. Controlling the operation of the print head comprises depositing the insulator and the low-melting-temperature metal in contact with each other over at least a portion of a substrate.

Another embodiment relates to a non-transitory computer-readable medium having instructions stored thereon, the instructions forming a program executable by a processing circuit to cause a printing device to perform operations for printing micro wires. The operations comprise receiving data specifying a structure to be printed at the printing device; and controlling the operation of a print head of the printing device based on the data. Controlling the operation of the print head comprises depositing an insulator and the low-melting-temperature metal in contact with each other over at least a portion of a substrate; and depositing, via the print head, droplets of a low-melting-temperature metal on at least a portion of the deposited insulator. The insulator may be provided by a first reservoir of the printing device, and the low-melting-temperature metal is provided by a second reservoir of the printing device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a block diagram of a system for printing micro wires, according to one embodiment.

FIG. 2 is a block diagram of a processing circuit of a printing device, according to one embodiment.

FIG. 3 is a schematic diagram of a print head of a printing device, according to one embodiment.

FIG. 4 is a flow diagram of a process for printing micro wires, according to one embodiment.

FIG. 5 is a flow diagram of a process for printing micro wires, according to one embodiment.

FIG. 6 is a flow diagram of a process for printing micro wires, according to one embodiment.

FIG. 7 is a flow diagram of a process for printing micro wires, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the scope of the subject matter presented here.

Referring generally to the figures, various embodiments of systems, methods, and computer readable media for printing micro wires (i.e., micro structures formed from deposited conductor and/or insulator) are shown and described. Gallium (Ga) is an element that melts at low temperatures, and alloys formed therefrom typically find applications as components of electronic circuits (e.g., wires, leads, etc.). Gallium alloys melt at low temperatures and are capable of wetting glass, among other substrates. According to the disclosure herein, by using an appropriate substrate (e.g., a rough or porous glass, a silicon dioxide (SiO₂) surface, etc.), the wetting and spreading of streams or droplets of low-melting-temperature metals can be controlled as they are dispensed via an inkjet-type printing device. In one embodiment, the low-melting-temperature metal is dispensed as a series of discrete droplets. In one embodiment, a piezoelectric-based inkjet print head is utilized. In another embodiment, an electromagnetic-based (non-thermal) inkjet print head is utilized. In general, the inkjet device holds an insulator in a reservoir. As an example, when using a glass-wetting low-melting-temperature metal, the insulator may be a water glass substance (e.g., sodium silicate, etc.). Other insulators may also be used. In another reservoir, the inkjet device holds a low-melting-temperature metal, which can supply print head. The low-melting-temperature metal may be held in the reservoir at or near a melting temperature of the metal, heated within the reservoir to a desired temperature (e.g., a melting temperature of the metal), or cooled within the reservoir to a desired temperature. The printing device may include heating or cooling elements in order to heat or cool the low-melting-temperature metal. The low-melting-temperature metal may be heated or cooled within the reservoir, during its travel to the print head, or within the print head itself. The low-melting-temperature metal may be heated after deposition by the print head, e.g., by optical irradiation, by resistive heating, by induction heating, or the like. The inkjet device can deposit the insulator over portions of the substrate (or over previously deposited low-melting-temperature metal), and then dispense the low-melting-temperature metal conductor on the deposited insulator. The inkjet device can deposit the low-melting-temperature metal over portions of the substrate (or over previously deposited insulator), and then dispense insulator on the deposited low-melting-temperature metal. When depositing the low-melting-temperature metal as droplets, the droplets of the low-melting-temperature metal conductor are typically on the micrometer scale. For example, the dispensed droplets can have a diameter of 10-microns or less. Various low-melting-temperature metal conductors (e.g., intermetallic solutions and alloys, eutectic alloys, etc.) may be used by the printing device. In one embodiment, the inkjet device utilizes a eutectic alloy formed primarily from gallium, indium, and tin (GaInSn). The inkjet device may be configured to apply heat to the low-melting-temperature metal in order to reach the melting temperature of the particular metal in use.

After droplets of the low-melting-temperature metal conductor are deposited, the printing device may further deposit the insulator over the deposited metal. In this manner, the deposited metal can be sealed. The insulator may be dispensed by the print head in various configurations, based on a structure being printing. For example, the printing device may deposit additional insulator at a crossing point of deposited metal. If a first circuit trace is being printed, the insulator can be deposited where a second circuit trace is going to cross over the first circuit trace (i.e. between the traces such that they are insulated from each other). In one embodiment, the insulator can be dispensed between layers of conductor. In another embodiment, the insulator is dispensed below and/or on top of a layer of conductor. In one embodiment, the insulator is dispensed both below and on top of a layer of conductor, e.g., to fully enclose the conductor within the insulator. Additionally, the permittivity and/or permeability of the insulator being used can be selected based on certain structures being printed. For example, an insulator with controlled permittivity or permeability may be dispensed and combined with the conductor in order to form a capacitor or inductor. Thus, the low-melting-temperature metal conductor can be deposited to form numerous shapes and circuit components (e.g., wires, pads, connectors, conductors, capacitors, inductors, antennas, etc.) as will be discussed further herein. Antennas formed by deposition of low-melting-temperature metal conductors can be used in active or passive RFID tags, e.g., in RFID tags printed onto a substrate.

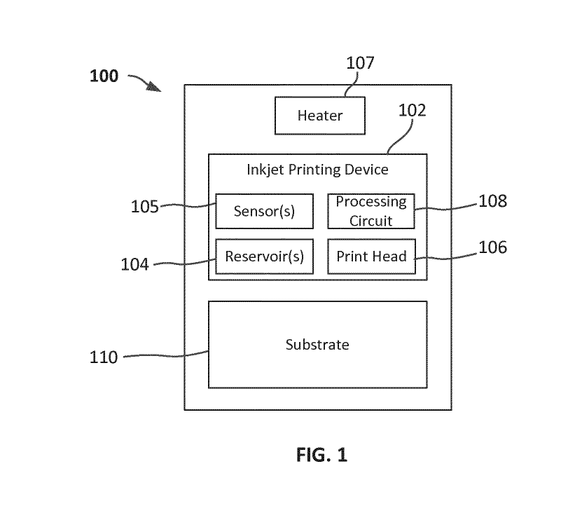

Referring to FIG. 1, system 100 for printing micro wires and structures is shown according to one embodiment. System 100 includes printing device 102, which may be an inkjet-type printing device. Printing device 102 includes one or more reservoirs 104, print head 106, and processing circuit 108. Reservoirs 104 are generally configured to hold the “ink” of printing device 102, which according to the disclosure herein includes a conductor (a low-melting-temperature metal) and an insulator. The low-melting-temperature metal may be various types of compounds, intermetallic solutions, intermetallic alloys, gallium-based eutectics, etc. In one embodiment, the low-melting-temperature metal is a GaInSn liquid metal alloy that melts near 254 Kelvin. The low-melting-temperature metal and the insulator may be stored in a single reservoir 104 that is divided into compartments, or the low-melting-temperature metal may be stored in individual reservoirs 104. The reservoir 104 that holds the low-melting-temperature metal may be configured to apply heat to the low-melting-temperature metal in order to raise the metal to a melting temperature (i.e. so that the low-melting-temperature metal becomes liquid). Reservoirs 104 may be part of print head 106, or reservoir 104 may be located externally from print head 106 (e.g., coupled to print head 106 via tubing/piping, etc.).

Print head 106 includes the necessary components to form and dispense droplets of the liquid low-melting-temperature metal and to dispense an insulator. Print head 106 may include a single nozzle configured to dispense both the metal and insulator, or print head 106 may include nozzles for each of the metal and insulator, or print head 106 may include separate print heads for each of the metal and insulator. The dispensed droplets are typically on the micrometer scale in order to allow for the printing of an arbitrary conductor pattern on substrate 110. Substrate 110 may include any substrate on which the liquid low-melting-temperature metal will wet. Accordingly, a particular substrate 110 may depend on the type of liquid low-melting-temperature metal utilized. For example, substrate 110 can include a glass-based substrate, a metal-clad substrate, or another substrate that is controlled to aid in the wetting of the liquid low-melting-temperature metal thereon. Substrate 110 may also include features or microstructures formed to enhance wetting or surface-tensions based reflow of the deposited low-melting-temperature metal. These may include pores, areas of rough surfaces, areas of surface treatments, silicon pillars, nanofibers, vias, etc. For example, in an embodiment using substrate 110 that includes vias or pores, printing device 102 may be configured to dispense droplets of the low-melting-temperature metal to fill the vias or to permeate the pores. After being dispensed, reheating of the metal or the surface tension of the metal may cause the deposited droplets to melt and coalesce into a continuous metallic conductor. After being dispensed, reheating of the metal or the surface tension of the metal may cause the deposited metal to reach a desired depth. Substrate 110 may also include a pre-formed layer of insulation on its surface. In one embodiment, print head 106 is a piezoelectric-based print head. In another embodiment, print head 106 is an electromagnetic-based print head. In some embodiments, printing device 102 includes the components (e.g., belts, stabilizer bars, stepper motors, ink-supply mechanisms, etc.) necessary to cause print head 106 to move to print on substrate 110. For example, print head 106 may be may be configured to move laterally back and forth, parallel to substrate 110. As another example, print head 106 may be configured to move in three dimensions and rotate about an axis. In other embodiments, print head 106 is a fixed print head, and a feeder mechanism is configured to move substrate 110 (e.g., laterally back and forth, up and down, or rotated, etc.) on which the low-melting-temperature metal and insulator are dispensed.

Processing circuit 108 controls the operation of printing device 102. Processing circuit 108 receives data specifying a structure to be printed (e.g., data related to a circuit diagram, a circuit component, a wire, a structure, etc.). The data may be received via a wired connection or wirelessly (e.g., sent from another computing device, etc.) In one embodiment, printing device 102 includes a media card reader (e.g., a compact flash reader, a secure digital (SD) card reader, or the like) and the data specifying a structure to be printed is a file stored on the media card. The data may also be stored in memory, and processing circuit 108 generates the appropriate signals to cause print head 106 to dispense droplets of the liquid low-melting-temperature metal and the insulator. For example, processing circuit 108 may generate signals related to flow rates of the metal and/or insulator, print head 106 movements and positioning, substrate 110 movements and positioning, etc.

In some embodiments, printing device 102 includes one or more sensors 105 to monitor the printing. In one embodiment, sensor 105 is or includes a camera to image the printed structure, e.g., using polarized, IR, visible, or UV light. In another embodiment an ultrasonic sensor (e.g., a transducer to deliver ultrasound and to receive reflected ultrasound) is used to monitor deposited metal and insulator structures (e.g., to detect buried interfaces, to form 3D images of multi-layered depositions, etc.). In other embodiments, thermal sensors (e.g., using IR emissions or direct contact), are used to measure the temperature of the deposited insulator and metal. In another embodiment a resistance sensor is used to measure the electrical resistance within the deposited insulator or metal, or to measure resistance between different components (i.e., between the substrate, the metal, and/or, the insulator). In some embodiments, such sensor data is used by processing circuit 108 to control operation of printing device 102.

In one embodiment, system 100 further includes heater 107. Heater 107 is configured to provide thermal energy to printing device 102, substrate 110, or one or both of the insulator and the low-melting-temperature metal. Heater 107 may be configured to provide thermal energy to any or all of the substrate, insulator, or low-melting-temperature metal before, during, or after deposition of the insulator or low-melting-temperature metal onto the substrate.

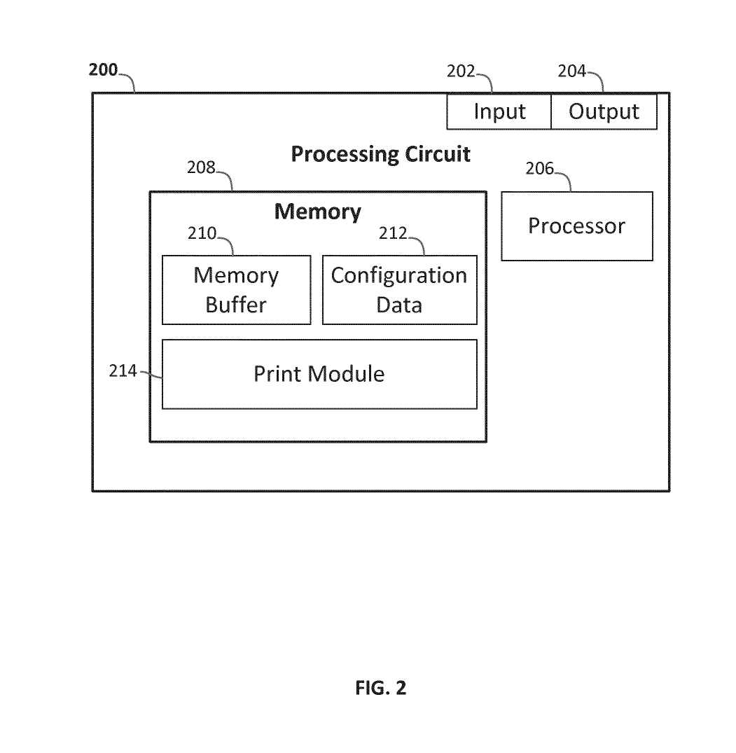

Referring to FIG. 2, a block diagram of processing circuit 200 for completing the systems and methods of the present disclosure is shown according to one embodiment. Processing circuit 200 is generally configured to receive data related to a structure to be printed by a printing device, and to control the printing device in order to print the structure. Processing circuit 200 is further configured to receive configuration data. Input data may be accepted continuously or periodically. Processing circuit 200 uses the input data to generate the signals necessary to cause a low-melting-temperature metal and insulator to be dispensed on a substrate via a print head. Processing circuit 200 also generates the signals necessary to control operation of various components of the printing device (e.g., controlling a heating element, starting/stopping of the device, etc.). Processing circuit 200 also generates reporting data based on printed structures and formats the data to be transmitted. For example, processing circuit 200 may transmit status reports as a structure is being printed or may transmit information related to temperatures or amounts of low-melting-temperature metal and insulator (e.g., amounts used or remaining in reservoirs, etc.). In controlling the printing device and in generating reporting data, processing circuit 200 may make use of machine learning, artificial intelligence, interactions with databases and database table lookups, pattern recognition and logging, intelligent control, neural networks, fuzzy logic, etc. Processing circuit 200 further includes input 202 and output 204. Input 202 is configured to receive a data stream and configuration information. Output 204 is configured to output data for transmission (e.g., via a transmitter).

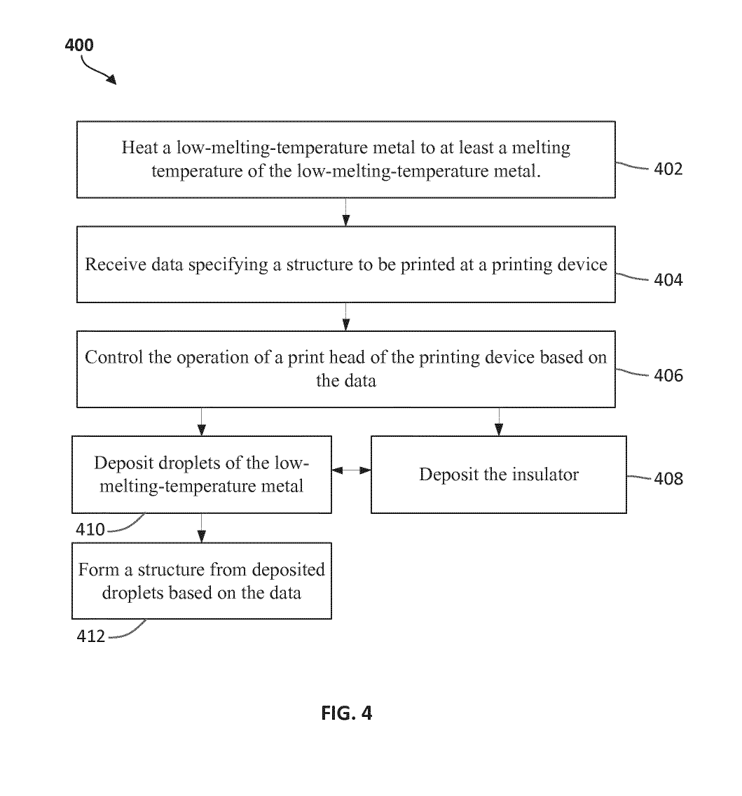

According to one embodiment, processing circuit 200 includes processor 206. Processor 206 may be implemented as a general-purpose processor, an application specific integrated circuit (ASIC), one or more field programmable gate arrays (FPGAs), a digital-signal-processor (DSP), a group of processing components, or other suitable electronic processing components. Processor 206 may be any commercially available processor. Processing circuit 200 also includes memory 208. Memory 208 includes one or more devices (e.g., RAM, ROM, Flash Memory, hard disk storage, etc.) for storing data and/or computer code for facilitating the various processes described herein. Memory 208 may be or include non-transient volatile memory or non-volatile memory. Memory 208 may include database components, object code components, script components, or any other type of information structure for supporting the various activities and information structures described herein. Memory 208 may be communicably connected to processor 206 and provide computer code or instructions to processor 206 for executing the processes described herein (e.g., the processes shown in FIGS. 4-7). Memory 208 includes memory buffer 210. Memory buffer 210 is configured to receive a data stream from a file or through input 202. For example, the data may include a stream of data related to a structure to be printed by a printing device. The data received through input 202 may be stored in memory buffer 210 until memory buffer 210 is accessed for data by the various modules of memory 208. For example, print module 214 can access the data that is stored in memory buffer 210. Any data received through input 202 may also be immediately accessed.

Memory 208 further includes configuration data 212. Configuration data 212 includes data related to processing circuit 200. For example, configuration data 212 may include information related to interfacing with other components (e.g., the print head, actuators, motors, etc.). Based on data stored in configuration data 212, processing circuit 200 may format data for output via output 204, which may include formatting reporting and status data for transmission via a transmitter, etc. For example, processing circuit 200 may format into packets a status report related to a printed circuit for transmission according to a networking protocol. Processing circuit 200 may also format data for transmission according to any additional protocols as specified by configuration data 212. Configuration data 212 may further include information as to how often input should be accepted from a sensor device. Configuration data 212 may include default values required to initiate communication with an external device (e.g., a remote computer, etc.) and any components of the system having processing circuit 200. Configuration data 212 further includes data to configure communication between the various components of processing circuit 200.

Memory 208 further includes print module 214. Print module 214 is configured to receive print data and configuration information. Print module 214 generates signals to cause the print head of printing device to write droplets of a low-melting-temperature metal and an insulator onto a substrate. Print module 214 monitors the writing process (e.g., the amounts of low-melting-temperature metal and insulation utilized, etc.), provides feedback data for transmission, and causes data to be transmitted via a transmitter (e.g., via output 204).

In one embodiment, a printing device (e.g., system 100) controlled by processing circuit 200 is configured to write low-melting-temperature conductor and insulation onto a substrate, as described in further detail below. The substrate may be a metal substrate and the conductor may be a glass-wetting liquid conductor (e.g., a gallium alloy, a GaInSn solution, etc.). In order to allow the conductor to wet, a layer of insulation may first be applied to the substrate in areas where the conductor is to be dispensed. In one embodiment, the insulator is a sodium silicate based insulator. The insulator may be applied over a wide area of the substrate, over an entire surface of the substrate, or only in specific areas where the conductor is to be applied (e.g., based on the structure to be written by the printing device). For example, when writing a wire, the insulator may be applied under the length of the wire, and the wire then written on top of the insulator. After the conductor is applied, it may be desirable to cover the exposed conductor with an additional layer of insulation. Accordingly, the printing device may apply a layer of insulation over the applied conductor. In one embodiment, the printing device covers the substrate with a cap layer of insulation. In another embodiment, the printing device covers any written conductor with a layer of insulation. In another embodiment, additional insulation is applied based on a crossing point of multiple layers of conductor. In this manner, various layers of conductors may be written (with insulator deposited therebetween) by the printing device into two-dimensional and three-dimensional structures. As an example, based on data specifying the structure to be printed, it may be known that a second wire trace crosses a first wire trace. The printing device can then apply an area of insulation at the crossing point in between the second and first wire traces so that the second wire trace is insulated from the first wire trace.

The dispensed droplets of conductor can be formed into various shapes by the print head of the printing device. For example, the conductor may be written into a wire, a pad, or other circuit components. After being written, the components can be used for electrical or thermal purposes (i.e., as contacts or conductors). In one embodiment, the final shape of the conductors may be developed via the application of heat after initial application. For example, the print head may print dots or patterns of the conductor, such that they may flow together to form a final shape when heated. In another embodiment, the composition of the conductor may be varied across a printed structure in order to alter a melting point of the conductor after it is dispensed.

Various properties of the low-melting-temperature metal conductor may be selected depending on a desired application. In one embodiment, the wetting or surface tension properties of the conductor, and any co-deposited material (e.g., flux), can be chosen to control their subsequent reflow or coalescence. For example, the wetting properties of an alloy conductor may be spatially varied based on the substrate and device. The conductor may also be applied with small particles (e.g., metal or dielectric nano-particles) that are added to the reservoir with the conductor (or are premixed with the conductor). The particles can have certain desired wetting properties that are selected to cause the deposited conductor to confine to narrow tracks, vias, pores, or layouts.

In some embodiments, the conductor is applied as a paste along with an appropriate flux. Shear thinning properties of the paste may be exploited by the print head to facilitate a flow of the paste. The flux may be mixed with the paste in a reservoir of the printing device (e.g., a reservoir 104 of FIG. 1). Alternatively, the flux may be dispensed along with the dispensed conductor (e.g., via a separate nozzle of the print head) and stored in a separate reservoir. The particular flux used may be selected based on desired properties. In one embodiment, the flux is a wetting inhibitor. In another embodiment, the flux is a wetting enhancer. In another embodiment, the flux is a surface treatment for the substrate. In another embodiment, the flux includes an evaporable material and metal particles that may be alloyed after application.

The insulator dispensed by the printing device may be based on various types of material. For example, an insulator may be based on plastics, glass, ceramics, etc. In one embodiment, a thermo-setting resin insulator is used. The thermo-setting of the resin insulator may occur as the insulator is dispensed via the print head or later. In one embodiment the thermo-setting of such a resin insulator can be controlled. For example, the printing device may be equipped with facilities to appropriately control relative surface energies so a desired structure of the dispensed resin is set and maintained. In one embodiment, the print head includes heated tip features that are configured to apply heat in order to cause a dispensed thermo-setting resin to cure after the resin is deposited.

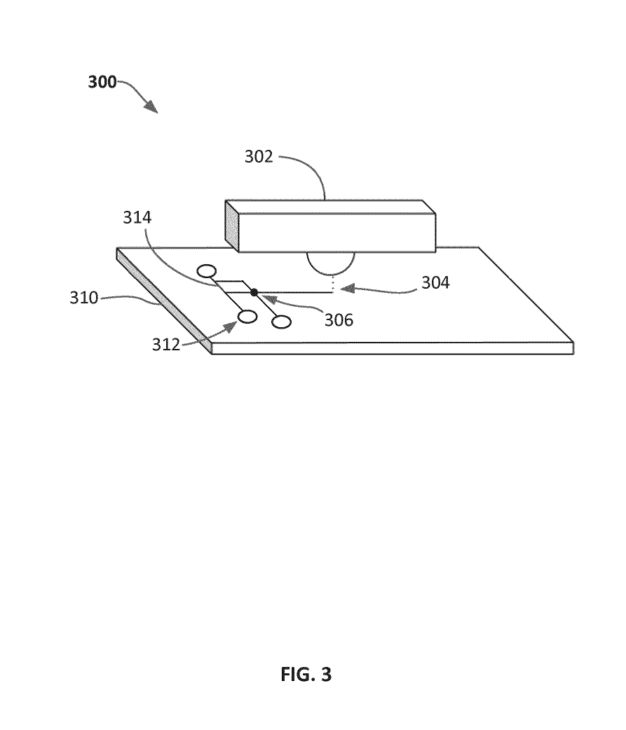

Referring to FIG. 3, a schematic diagram 300 of print head 302 of a printing device and substrate 310 are shown, according to one embodiment. Print head 302 may be an inkjet print head as described herein and is configured to write both low-melting-temperature metal conductors and insulation on a surface of substrate 310. Print head 302 can be coupled to one or more reservoirs of the printing device, which supply print head 302 with one or more conductors and insulators to be dispensed. In one embodiment, print head 302 is configured to move in two or three dimensions. In one embodiment, substrate 310 is configured to move in two or three dimensions and print head 302 may be primarily stationary. As indicated, print head 302 dispenses droplets 304 of the conductors to wet on substrate 310. Print head 302 may include one or more nozzles used to dispense the conductors and insulators. As an example, print head 302 may be a piezoelectric-based inkjet print head. As another example, print head 302 may be an electromagnetic-based inkjet print head. The droplets 304 of conductor may be dispensed to fill a via 312 or other structures on substrate 310 (e.g., pores, channels, tracks, etc.). As discussed above, print head 302 may dispense the insulator above and beneath droplets of conductor. For example, a trace of wire 314 may be written by print head 302. However, prior to writing wire 314, a strip of insulator may be dispensed under the trace of wire 314 (e.g., a water glass insulator may be dispensed when using a glass-wetting conductor). As another example, insulator may be dispensed in between two traces of conductor at the crossing point 306 (e.g., on top of the first trace and below the second trace, etc.). Any of the applied conductors may also be sealed by a layer of insulator by print head 302.

Referring to FIG. 4, a flow diagram of a process 400 for writing a micro structure is shown, according to one embodiment. In alternative embodiments, fewer, additional, and/or different actions may be performed. Also, the use of a flow diagram is not meant to be limiting with respect to the order of actions performed. A low-melting-temperature metal conductor is heated to at least a melting temperature of the low-melting-temperature metal (402). The conductor may then be dispensed while in a liquid state. Data related to a structure be printed is received at a printing device (404). For example the data may be received by a wired or wireless network connection, or a via storage media that is inserted into a reader of the printing device. The operation of a print head of the printing device is controlled based on the data specifying a structure to be printed (406). For example, the movement of the print head, rate of flow of dispensed conductor and insulator, temperature of the conductor and insulator, etc., may be controlled based on the structure to be printed. The insulator can be deposited on a substrate in an area where the conductor is to be written (408). Droplets of the low-melting-temperature metal conductor are deposited on areas of previously deposited insulator (410). A structure (e.g., a circuit shape or component based on the data) is formed by the deposited droplets (412).

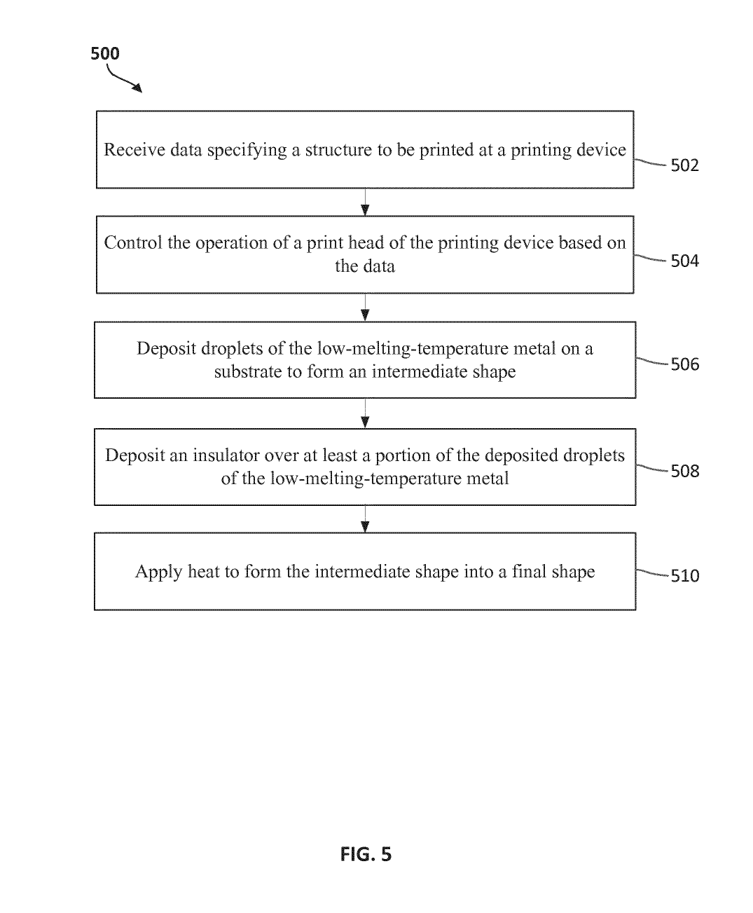

Referring to FIG. 5, a flow diagram of a process 500 for writing a micro structure is shown, according to one embodiment. In alternative embodiments, fewer, additional, and/or different actions may be performed. Also, the use of a flow diagram is not meant to be limiting with respect to the order of actions performed. Data specifying a structure to be printed is received at a printing device (502). The operation of a print head of the printing device is controlled based on the data (504). Droplets of the low-melting-temperature metal are deposited on a substrate to form an intermediate shape (506). An insulator is deposited over at least a portion of the deposited droplets of the low-melting-temperature metal (508). Heat is applied to form the intermediate shape into a final shape (510). For example, a group of printed dots of conductor may flow together into a final shape in response to the applied heat.

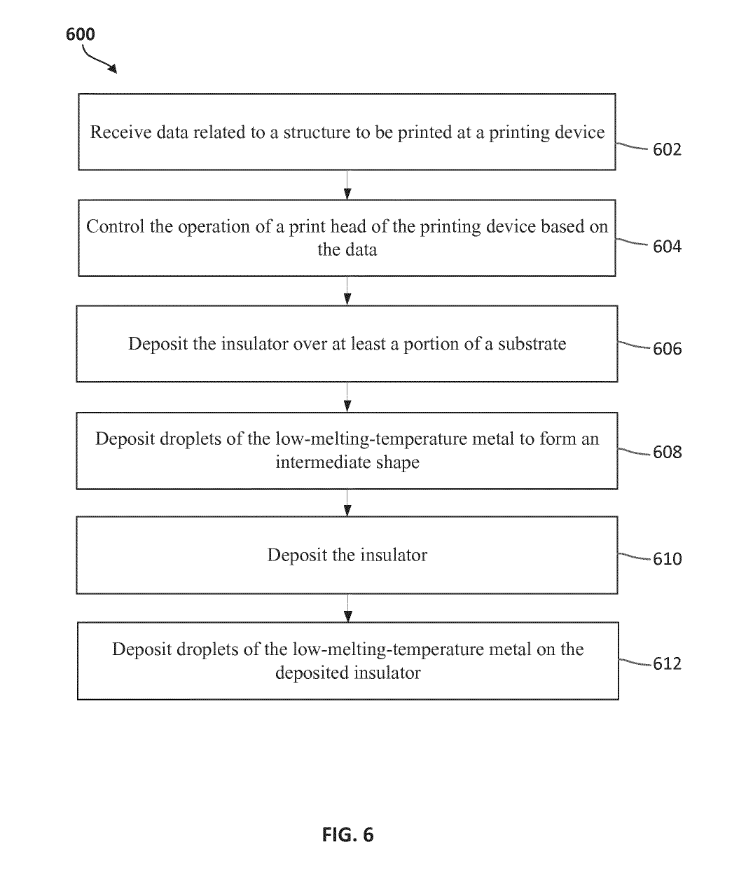

Referring to FIG. 6, a flow diagram of a process 600 for writing a micro structure is shown, according to one embodiment. In alternative embodiments, fewer, additional, and/or different actions may be performed. Also, the use of a flow diagram is not meant to be limiting with respect to the order of actions performed. Data related to a structure to be printed is received at a printing device (602). The operation of a print head of the printing device is controlled based on the data (604). Insulator is deposited over at least a portion of a substrate to form a base layer of insulation (606). Droplets of the low-melting-temperature metal are dispensed to form an intermediate shape (608). Another layer of insulation is dispensed (610). For example, the additional layer of insulation may form a seal over a portion of the substrate (and printed structure) or over the entire substrate. An additional layer of droplets of the low-melting-temperature metal are deposited on the deposited insulator (612). In this manner, a three-dimensional layered structure) having insulation between layers) may be formed.

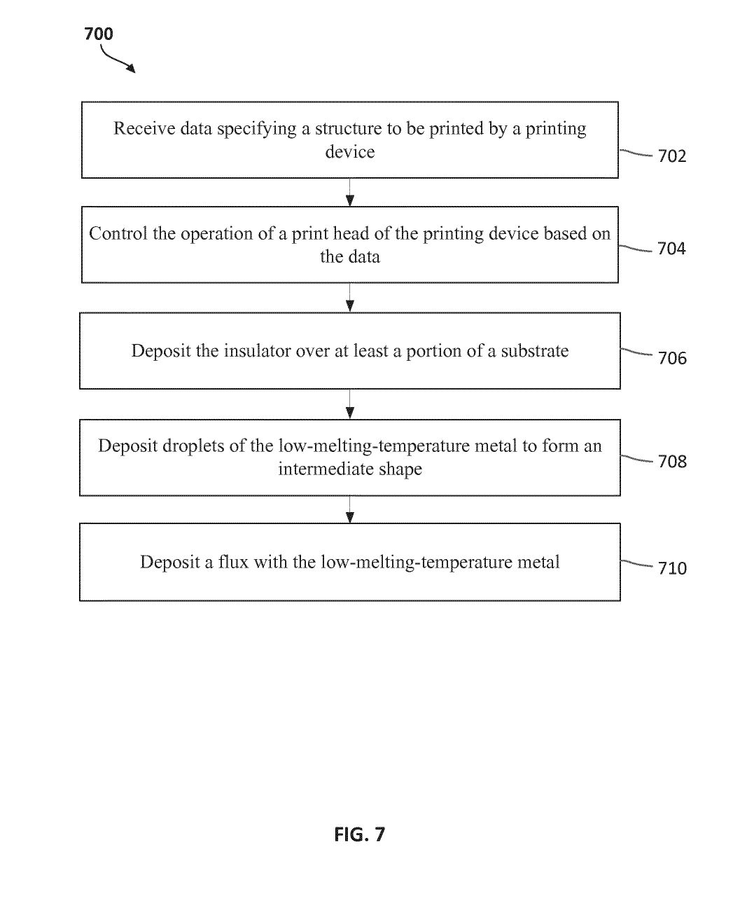

Referring to FIG. 7, a flow diagram of a process 700 for writing a micro structure is shown, according to one embodiment. In alternative embodiments, fewer, additional, and/or different actions may be performed. Also, the use of a flow diagram is not meant to be limiting with respect to the order of actions performed. Data specifying a structure to be printed is received at a printing device (702). The operation of a print head of the printing device is controlled based on the data (704). Insulator is dispensed over at least a portion of a substrate (706). Droplets of the low-melting-temperature metal are deposited to form an intermediate shape (708). The low-melting-temperature metal may be in a paste form to be applied with a flux. The flux may be included in the paste or retained separately (e.g., in a separate reservoir of the printing device). In this manner, the flux is dispensed with the low-melting-temperature metal (710).

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the embodiments without departing from the scope of the present disclosure.

The present disclosure contemplates methods, systems and program products on any machine-readable media for accomplishing various operations. The embodiments of the present disclosure may be implemented or modeled using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. All such variations are within the scope of the disclosure. Likewise, software implementations could be accomplished with standard programming techniques with rule-based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. An printing device for printing of micro wires, comprising:
a first reservoir configured to hold an insulator;
a second reservoir configured to hold a low-melting-temperature metal;
a print head configured to:
deposit the insulator and the low-melting-temperature metal in contact with each other over at least a portion of a substrate;
a processing circuit configured to:
receive data specifying a structure to be printed; and
control the operation of the print head based on the data.

2. The printing device of claim 1, further comprising a heater configured to supply thermal energy to the low-melting temperature metal.

3. The printing device of claim 1, wherein the print head is configured to deposit the low-melting temperature metal as a plurality of droplets.

4. The printing device of claim 1, wherein the print head comprises a first print head configured to deposit the insulator and a second print head configured to deposit the low-melting temperature metal.

5. The printing device of claim 1, further comprising a sensor to measure the electrical resistance of at least one of the deposited insulator and the deposited low-melting temperature metal.

6. The printing device of claim 1, further comprising a sensor to measure the electrical resistance between a first point and a second point, wherein each of the first and second points are located on at least one of the substrate, the deposited insulator, and the deposited low-melting temperature metal.

7. The printing device of claim 1, further comprising a sensor, wherein the processor is further configured to control the operation of the print head based on data measured by the sensor.

8. The printing device of claim 7, wherein the sensor includes at least one of a camera, a thermal sensor, an ultrasonic sensor, and an electrical resistance sensor.

9. The printing device of claim 1, wherein the low-melting-temperature metal comprises a gallium alloy.

10. The printing device of claim 9, wherein the gallium alloy comprises GaInSn.

11. The printing device of claim 1, wherein the low-melting-temperature metal comprises a eutectic alloy.

12. The printing device of claim 1, wherein the print head comprises a piezoelectric-based print head.

13. The printing device of claim 1, wherein the print head comprises an electromagnetic-based print head.

14-15. (canceled)

16. The printing device of claim 1, wherein the processing circuit is configured to control the print head to form an intermediate shape, and wherein the intermediate shape is configured to be formed into a final shape after depositing.

17. The printing device of claim 16, wherein the intermediate shape comprises an array of dots, wherein the array of dots is configured to be melted to form the final shape via the application of heat after depositing.

18-21. (canceled)

22. The printing device of claim 1, wherein the print head is configured to deposit the low-melting-temperature metal over at least a portion of the deposited insulator.

23. The printing device of claim 22, wherein the print head is configured to deposit a second portion of the insulator over at least a portion of the deposited low-melting-temperature metal.

24. (canceled)

25. The printing device of claim 22, wherein the print head is configured to deposit a second portion of the low-melting-temperature metal over at least a portion of the deposited insulator.

26-37. (canceled)

38. A method of printing micro wires, comprising:
holding, in a first reservoir, an insulator;
holding, in a second reservoir, a low-melting-temperature metal;
receiving data specifying a structure to be printed at a printing device; and
controlling the operation of a print head of the printing device based on the data, wherein controlling the operation of the print head comprises:
depositing the insulator and the low-melting-temperature metal in contact with each other over at least a portion of a substrate.

39. (canceled)

40. The method of claim 38, wherein the low-melting temperature metal is heated after deposition.

41. The method of claim 38, wherein the low-melting temperature metal is heated before deposition.

42-45. (canceled)

46. The method of claim 38, further comprising using a sensor to acquire sensor data associated with at least one of an image, an electrical resistance, an ultrasonic response, and a temperature.

47. The method of claim 38, further comprising controlling the operation of the print head of the printing device based on the sensor data.

48-60. (canceled)

61. The method of claim 38, further comprising depositing, with the print head, the low-melting-temperature metal over at least a portion of the deposited insulator.

62. The method of claim 61, further comprising depositing, with the print head, a second portion of the insulator over at least a portion of the deposited low-melting-temperature metal.

63-76. (canceled)

77. A non-transitory computer-readable medium having instructions stored thereon, the instructions forming a program executable by a processing circuit to cause a printing device to perform operations for printing micro wires, the operations comprising:
receiving data specifying a structure to be printed at the printing device; and
controlling the operation of a print head of the printing device based on the data, wherein controlling the operation of the print head comprises:
depositing an insulator and a low-melting-temperature metal in contact with each other over at least a portion of a substrate.

78-84. (canceled)

85. The non-transitory computer-readable medium of claim 77,
wherein the data comprises a shape, and controlling the print head further includes forming the shape, wherein the shape comprises at least one of a wire, a pad, a contact, and a conductor.

86-88. (canceled)

89. The non-transitory computer-readable medium of claim 77, wherein the operations further comprise varying an alloy composition of the low-melting-temperature metal.

90-97. (canceled)

98. The non-transitory computer-readable medium of claim 77, wherein the deposited low-melting-temperature metal forms a circuit component.

99. The non-transitory computer-readable medium of claim 98, wherein the circuit component comprises at least one of a conductor, a capacitor, and an inductor.

100. (canceled)

101. The non-transitory computer-readable medium of claim 77, wherein the substrate comprises vias.

102. (canceled)

103. The non-transitory computer-readable medium of claim 77, wherein the operations further comprise depositing a flux with the low-melting-temperature metal.

104. The non-transitory computer-readable medium of claim 103, wherein the flux comprises at least one of a wetting inhibitor, a wetting enhancer, a surface treatment for the substrate, and an evaporable material.

105-106. (canceled)

107. The non-transitory computer-readable medium of claim 77, wherein a microstructure of the substrate is formed to aid in a wetting or surface-tension based reflow of the low-melting-temperature metal.

108. The non-transitory computer-readable medium of claim 107, wherein the microstructure of the substrate comprises wetting enhancing structures, and wherein the wetting enhancing structures comprise at least one of pores, silicon pillars, nanofibers, areas of surface roughening, and areas of surface treatment.
